(19) United States
(12) Patent Application Publication
(10) Pub. No.: US 2007/0157785 A1
(43) Pub. Date: Jul. 12, 2007

(54) Paper cutter structure having dual cutters

(76) Inventor: Tung-Lung Chiang, Tou Liu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,410

(22) Filed: Jan. 6, 2006

(51) Int. Cl. B26D 5/08

(52) U.S. Cl. 83/607; 83/614

(57) ABSTRACT

A paper cutter structure having dual cutters includes a main body in a slanting-shaped design, with a slide cutter set secured to one end at one side of the main body and a push-down cutter set secured to an opposite end at the other side of the main body. The main body comprises a main board and supports formed on four corners of the main board with two as a set at one side upwardly and the other two supports as another set at the other side downwardly. The supports maintain the top surface of the main body in a flat level no matter if the slide cutter set or the push cutter set is being used.

### BACKGROUND OF THE INVENTION

1. Field of the Invention

This invention relates to a paper cutter structure having dual cutters, and more particularly, to a paper cutter having a slide cutter set and a push-down cutter set.

2. Description of the Prior Art

A conventional paper cutter currently in the market comprises only one function either a slide cutter set or a push-down cutter set. For different purposes, the user has to purchase two paper cutters.

A paper cutter having a slide cutter set and a push-down cutter set was later derived, which installs both cutter sets at respective ends. However, because the two cutter sets are mounted at the same side, it interferes with each other in operation.

Further, some models are designed to have the cutter sets removable, which means only one cutter set may be mounted at a time. This makes no difference with the conventional one.

### SUMMARY OF THE INVENTION

It is the primary objective of the present invention to provide a paper cutter structure having dual cutters, which is mounted double cutter sets in two different surfaces of a main body to save space.

It is another objective of the present invention to provide a paper cutter structure having dual cutters, which is easy to operate.

It is a further objective of the present invention to provide a paper cutter structure having dual cutters, which is cost-effective in manufacture.

### BRIEF DESCRIPTION OF THE DRAWINGS

FIG. 1 is a perspective view of the present invention, showing that a slide cutter set is in use;

FIG. 2 is another perspective view of the present invention, showing that a push-down cutter set is in use; and

FIG. 3 is a front view of the present invention.

### DETAILED DESCRIPTION OF THE PREFERRED EMBODIMENT

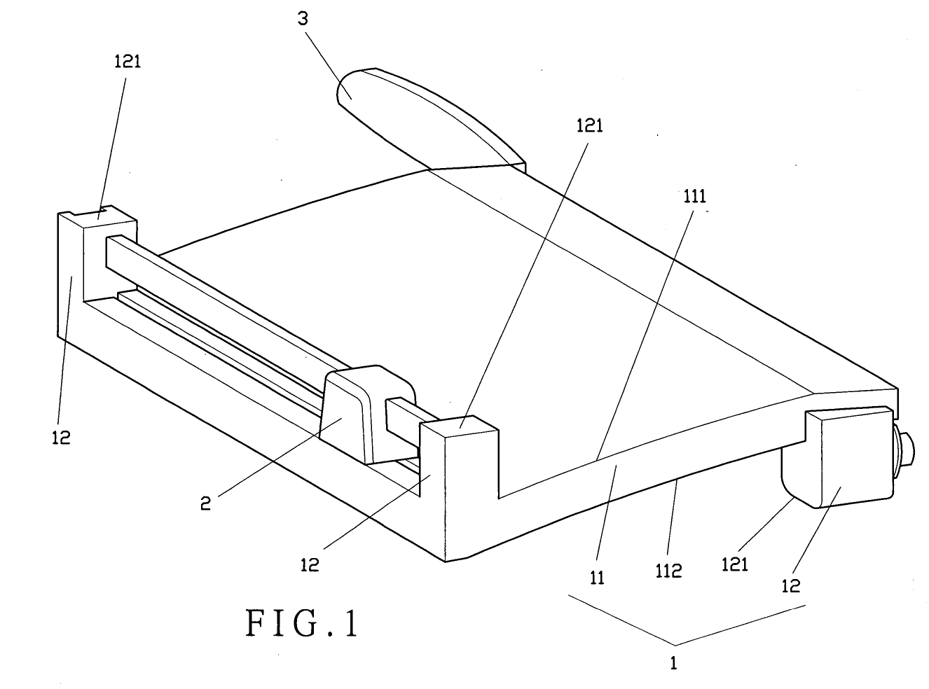

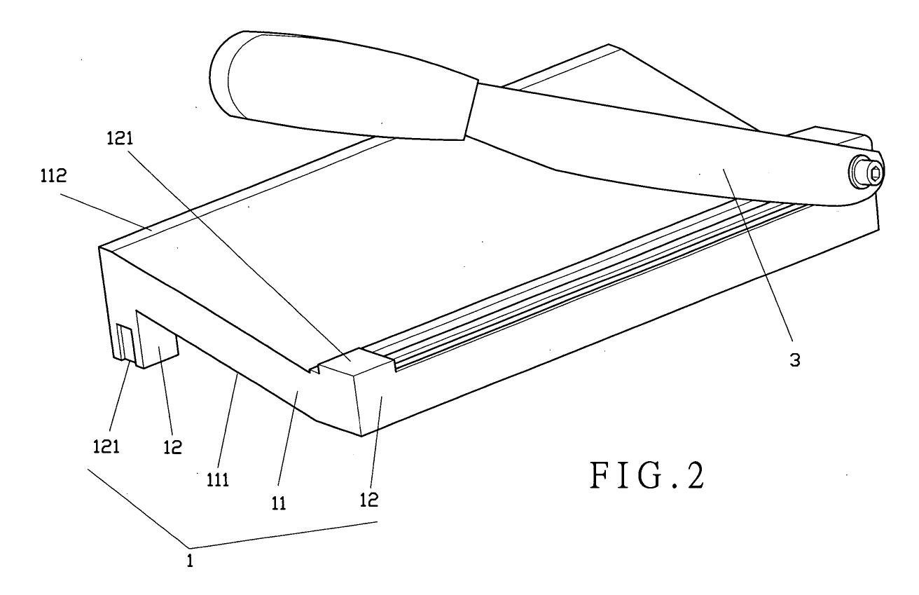

As shown in FIGS. 1 and 2, the present invention comprises a main body 1, a slide cutter set 2, and a push-down cutter set 3.

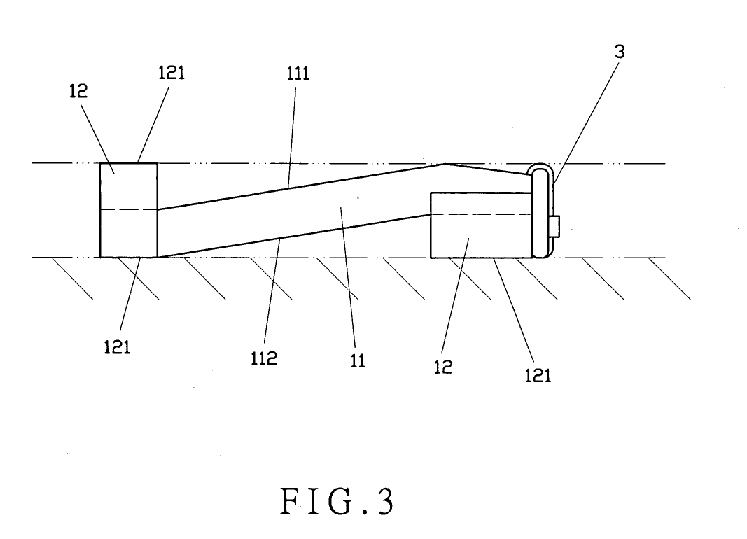

The main body 1 is a slanting-shaped design and includes a main board 11 and supports 12. The main body 11 has a top surface 111 and a bottom surface 112 thereof. The supports 12 are secured on four corners of the main board 11, with two supports 12 facing up and the other two facing down. The bottom ends 121 of the supports 12 at the side of the push-down cutter set 3 have the same level as the bottom surface 112, as shown in FIG.3. On the contrary, the bottom ends 121 of the supports 12 at the side of the slide cutter set 2 have the same level as the upper surface 111. The slide cutter set 2 and the push-down cutter set 3 are secured to the supports 12 at respective sides. Thereby, turning the main body 1 switches the paper cutter from slide cutter function to push-down cutter function.

I claim:

1. A paper cutter structure having dual cutters comprising a main body, a slide cutter set, a push-down cutter set, said main body comprising a main board and supports, said main board having a top surface at one side and a bottom surface at an opposing side with two of said supports on said top surface and the other two on said bottom surface of said main body, said supports having bottom ends which are the same level as said top surface or said bottom surface, said slide cutter set and said push-down cutter set being secured to said supports at opposite sides of said main board, respectively.

2. The paper cutter structure having dual cutters, as recited in claim 1, wherein either one side of said top surface is provided with a pair of supports or one side of said bottom surface is provided with another pair supports.

3. The paper cutter structure having dual cutters, as recited in claim 2, wherein said main body is a slanting-shaped design.
